(19) United States
(12) Patent Application Publication
(10) Pub. No.: US 2014/0136160 A1
(43) Pub. Date: May 15, 2014

(54) QUANTITATIVE MODELS OF MULTI-ALLELIC MULTI-LOCI INTERACTIONS

(71) Applicant: INTERNATIONAL BUSINESS MACHINES CORPORATION, Armonk, NY (US)

(72) Inventors: David HAWS, New York, NY (US); Laxmi P. PARIDA, Mohegan Lake, NY (US)

(73) Assignee: INTERNATIONAL BUSINESS MACHINES CORPORATION, Armonk, NY (US)

(21) Appl. No.: 13/675,475

(22) Filed: Nov. 13, 2012

(51) Int. Cl. G06F 17/10

(52) U.S. Cl. CPC G06F 17/10
USPC 703/2

(57) ABSTRACT

Various embodiments generate a quantitative model of multi-allelic multi-loci interactions. In one embodiment, a plurality of distinct allelic forms of at least two loci of an entity is received. Each of the plurality of distinct allelic forms is associated with a set of genotypes. A contribution value of each genotype to a given physical trait is determined for each set of genotypes. An interaction contribution value for each interaction between each of the set of genotypes of a first of the least two loci and each of the set of genotypes of at least a second of the least two loci to the physical trait is determined from at least one interaction model. A model of a quantitative value of the entity is generated based on the contribution value of each genotype in each set of genotypes and each interaction contribution value that has been determined from the interaction model.

### BACKGROUND

The present invention generally relates to the field of computational biology, and more particularly relates to modeling interactions between genes.

Nearly all physical characteristics of an organism can be partially explained by its genetic code. The genetic code (genome) of an organism is composed of multiple chromosomes, and each chromosome contains many genes (loci). Each genome includes two copies of each gene, and each gene may have multiple forms called alleles. The allelic composition of the genomes among individuals in a population (e.g. humans) can explain a wide variety of differing characteristics such as eye color. Quantitative models can be used describe how alleles contribute to a physical trait. However, most conventional models generally model the contribution of each locus independently.

### BRIEF SUMMARY

In one embodiment, a computer implemented method for generating a quantitative model of multi-allelic multi-loci interactions is disclosed. The computer implemented method includes receiving, by a processor, a plurality of distinct allelic forms of at least two loci of an entity. Each of the plurality of distinct allelic forms is associated with a set of genotypes. A contribution value of each genotype to a given physical trait is determined for each set of genotypes. An interaction contribution value for each interaction between each of the set of genotypes of a first of the least two loci and each of the set of genotypes of at least a second of the least two loci to the physical trait is determined from at least one interaction model. A model of a quantitative value of the entity is generated based on the contribution value of each genotype in each set of genotypes and each interaction contribution value that has been determined from the at least one interaction model.

In another embodiment, an information processing system for generating a quantitative model of multi-allelic multi-loci interactions is disclosed. The information processing system includes a memory and a processor communicatively coupled to the memory. An interaction model generator is communicatively coupled to the memory and the processor. The interaction model generator is configured to perform a method. The method includes receiving a plurality of distinct allelic forms of at least two loci of an entity. Each of the plurality of distinct allelic forms is associated with a set of genotypes. A contribution value of each genotype to a given physical trait is determined for each set of genotypes. An interaction contribution value for each interaction between each of the set of genotypes of a first of the least two loci and each of the set of genotypes of at least a second of the least two loci to the physical trait is determined from at least one interaction model. A model of a quantitative value of the entity is generated based on the contribution value of each genotype in each set of genotypes and each interaction contribution value that has been determined from the at least one interaction model.

In a further embodiment, a non-transitory computer program product for generating a quantitative model of multi-allelic multi-loci interactions is disclosed. The computer program product includes a storage medium readable by a processing circuit and storing instructions for execution by the processing circuit for performing a method. The method includes receiving a plurality of distinct allelic forms of at least two loci of an entity. Each of the plurality of distinct allelic forms is associated with a set of genotypes. A contribution value of each genotype to a given physical trait is determined for each set of genotypes. An interaction contribution value for each interaction between each of the set of genotypes of a first of the least two loci and each of the set of genotypes of at least a second of the least two loci to the physical trait is determined from at least one interaction model. A model of a quantitative value of the entity is generated based on the contribution value of each genotype in each set of genotypes and each interaction contribution value that has been determined from the at least one interaction model.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates one example of a contribution line representing the relative contribution to a physical trait by a plurality of genotypes according to one embodiment of the invention;

FIG. 3 illustrates the inverse of the contribution line of FIG. 2 according to one embodiment of the invention;

FIG. 4 illustrates one example of an encoding for a contribution line according to one embodiment of the present invention;

FIG. 5 illustrates one example of an encoding for the inverse of the contribution line of FIG. 4 according to one embodiment of the present invention;

FIG. 6 illustrates one example of a contribution line for a tri-allelic locus according to one embodiment of the present invention;

FIG. 7 illustrates one example of an encoding for the contribution line of FIG. 6 according to one embodiment of the present invention;

FIG. 8 illustrates one example of an encoding for the inverse of the contribution line of FIG. 6 according to one embodiment of the present invention;

FIG. 9 illustrates one example of adjusting the granularity of the contribution line of FIG. 7 according to one embodiment of the present invention;

FIG. 10 illustrates one example of adjusting the granularity of the contribution line of FIG. 8 according to one embodiment of the present invention;

FIG. 11 illustrates a first example of an interaction model for bi-allelic loci according to one embodiment of the present invention;

FIG. 12 illustrates a second example of an interaction model for bi-allelic loci according to one embodiment of the present invention;

FIG. 13 illustrates a third example of an interaction model for bi-allelic loci according to one embodiment of the present invention;

FIG. 14 illustrates a first example of a dominance-based interaction model for bi-allelic loci according to one embodiment of the present invention;

FIG. 15 illustrates a second example of a dominance-based interaction model for bi-allelic loci according to one embodiment of the present invention;

FIG. 16 shows a first example of an interaction model for multi-allelic loci according to one embodiment of the present invention;

FIG. 17 shows a second example of an interaction model for multi-allelic loci according to one embodiment of the present invention;

FIG. 18 illustrates one example of a dominance-based interaction model for multi-allelic loci according to one embodiment of the present invention;

FIG. 19 illustrates one example of placing homogenous genotypes on a contribution line according to one embodiment of the present invention;

FIG. 20 illustrates one example of placing heterozygous genotypes and contribution values on the contribution line of FIG. 19;

FIG. 21 illustrates one example of performing a grain adjustment process on the contribution line of FIG. 20 according to one embodiment of the present invention; and

FIG. 22 is an operational flow diagram illustrating one example of a quantitative model of multi-allelic multi-loci interactions according to one embodiment of the present invention.

### DETAILED DESCRIPTION

Operating Environment

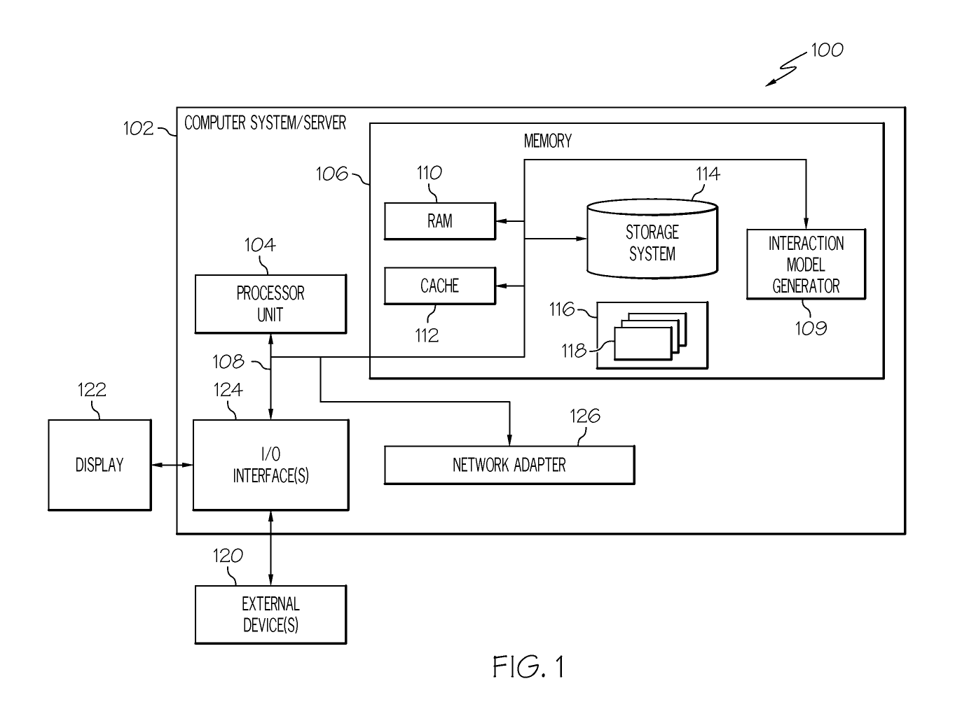

FIG. 1 illustrates a general overview of one operating environment 100 for generating quantitative models of multi-allelic multi-loci interactions for genetic simulation and prediction problems according to one embodiment of the present invention. In particular, FIG. 1 illustrates an information processing system 102 that can be utilized in embodiments of the present invention. The information processing system 102 shown in FIG. 1 is only one example of a suitable system and is not intended to limit the scope of use or functionality of embodiments of the present invention described above. The information processing system 102 of FIG. 1 is capable of implementing and/or performing any of the functionality set forth above. Any suitably configured processing system can be used as the information processing system 102 in embodiments of the present invention.

As illustrated in FIG. 1, the information processing system 102 is in the form of a general-purpose computing device. The components of the information processing system 102 can include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 106, in one embodiment, includes an interaction model generator 109 configured to perform one or more embodiments discussed below. For example, in one embodiment, the interaction model generator 109 is configured to generate quantitative models of multi-allelic multi-loci interactions. The interaction model generator 109 is discussed in greater detail below. It should be noted that even though FIG. 1 shows the interaction model generator 109 residing in the main memory, the interaction model generator 109 can reside within the processor 104, be a separate hardware component, and/or be distributed across a plurality of information processing systems and/or processors

The system memory 106 can also include computer system readable media in the form of volatile memory, such as random access memory (RAM) 110 and/or cache memory 112. The information processing system 102 can further include other removable/non-removable, volatile/non-volatile computer system storage media. By way of example only, a storage system 114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. The memory 106 can include at least one program product having a set of program modules that are configured to carry out the functions of an embodiment of the present invention.

Program/utility 116, having a set of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the present invention.

The information processing system 102 can also communicate with one or more external devices 120 such as a keyboard, a pointing device, a display 122, etc.; one or more devices that enable a user to interact with the information processing system 102; and/or any devices (e.g., network card, modem, etc.) that enable computer system/server 102 to communicate with one or more other computing devices. Such communication can occur via I/O interfaces 124. Still yet, the information processing system 102 can communicate with one or more networks such as a local area network (LAN), a general wide area network (WAN), and/or a public network (e.g., the Internet) via network adapter 126. As depicted, the network adapter 126 communicates with the other components of information processing system 102 via the bus 108. Other hardware and/or software components can also be used in conjunction with the information processing system 102. Examples include, but are not limited to: microcode, device drivers, redundant processing units, external disk drive arrays, RAID systems, tape drives, and data archival storage systems.

Interaction Modeling

One or more embodiments generate quantitative models of multi-allelic multi-loci interactions. As will be discussed in greater detail below, the interaction model generator 109 takes as input the number of distinct allelic forms for each of a plurality of genes/loci. The interaction model generator 109 also takes as input a relative contribution placement of the possible homozygous pairs of the alleles on a contribution line for each of the plurality of genes/loci. A contribution line is a representation of the contribution of each possible genotype for a given gene to a physical trait being simulated.

Based on the input the interaction model generator 109 computes heterozygous values as the average of the corresponding homozygous values. In one embodiment, the interaction model generator 109 determines the relative placement of the heterozygous values as a position on the contribution line that is between each of the corresponding homozygous values of the heterozygous value. The interaction model generator 109 determines if any of the homozygous positions and heterozygous positions overlap on the contribution line for each of the plurality of genes. If so, the interaction model generator 109 adjusts the grain of the contribution line such that no homozygous positions and heterozygous positions overlap. The interaction model generator 109 also receives a selection of a predefined interaction model and a predefined dominance model (if dominance is being accounted for). Based on the above, the interaction model generator 109 outputs a model of genetic value Vⱼ for an individual in the form of

$${V}_{j} = {\sum }_{i} {β}_{i} {x}_{ij} + {\sum }_{{i}_{1} > {i}_{2} > … > {i}_{k}} ( {α}_{{i}_{1} … {i}_{k}} {E}_{k} ( {x}_{{i}_{1}} , … , {x}_{{i}_{k}} ) + {γ}_{{i}_{1} … {i}_{k}} {D}_{k} ( {x}_{{i}_{1}} , … , {x}_{{i}_{k}} ) ) .$$

Variable j is the individual, i is a locus, k is an integer (the number of interacting loci), β is an impact scaling factor for locus i, α is a scaling factor for the contribution of the interaction between the k loci based on interaction model E, γ is a scaling factor for the contribution of the interaction between the k loci based on a dominance interaction model D, xᵢⱼ is the contribution encoding of gene (locus) i of the individual j being considered, E is the interaction model selected by the user, and D is the dominance model (if any) selected by the user. It should be noted that an individual is any entity comprising genes such as (but not limited to) a human, an animal, a plant, an insect, a microorganism, etc.

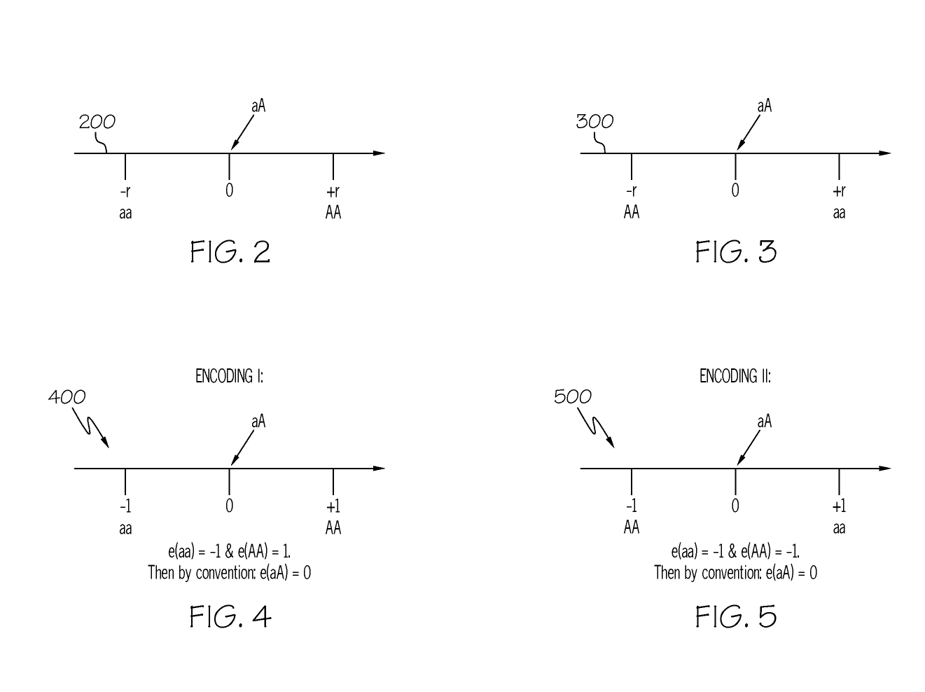

The following is a general framework for generating quantitative models of multi-allelic multi-loci interactions. It should be noted that even though diploids are used in the following framework this framework is applicable to other ploidy forms as well. In one embodiment, quantitative values are associated with categorical genotypes. For example, consider the bi-allelic (a, A) locus where the possible genotypes in a diploid are aa, AA and aA. An assumption is made that the quantitative contribution of aA is the arithmetic mean of aa and AA. The quantities associated with aa and AA determine whether aa and AA have a positive contribution or negative contribution, respectively, on the physical trait being simulated. For example, let r be some positive real number associated with this specific locus. Then as shown by the contribution line 200 in FIG. 2, the quantitative value of aa is −r, the quantitative value of aA is 0, and the quantitative value of AA is +r. That is, aa has a negative contribution on the physical trait, AA has a positive contribution on the physical trait, and aA has an intermediate contribution on the physical trait. Therefore, aa has the least contribution on the physical trait, AA has the greatest contribution on the physical trait, and aA has a contribution that is between aa and AA. Alternatively, as shown by the contribution line 300 of FIG. 3, the quantitative values of aa and AA can be +r and −r, respectively.

This leads to a natural encoding, written as e(aa) and e(AA) in the following embodiments. To summarize, the input for the bi-allelic case is only an indication that the locus is bi-allelic. Let the two alleles be, for example, a and A, then the only possible genotype values are aa, AA, and aA. The two encodings/models 400, 500 for the genotypes aa, AA, and aA are shown in FIGS. 4 and 5, respectively. The encoding 400 of FIG. 4 shows that e(aa)=−1 (negative impact) & e(AA)=1 (positive impact). Then by convention: e(aA)=0 (0 impact). The encoding 500 of FIG. 5 shows that e(aa)=1 & e(AA)=−1. Then by convention: e(aA)=0. It should be the scale of the contribution of each genotype is determined by the parameter of EQ. 6 discussed below.

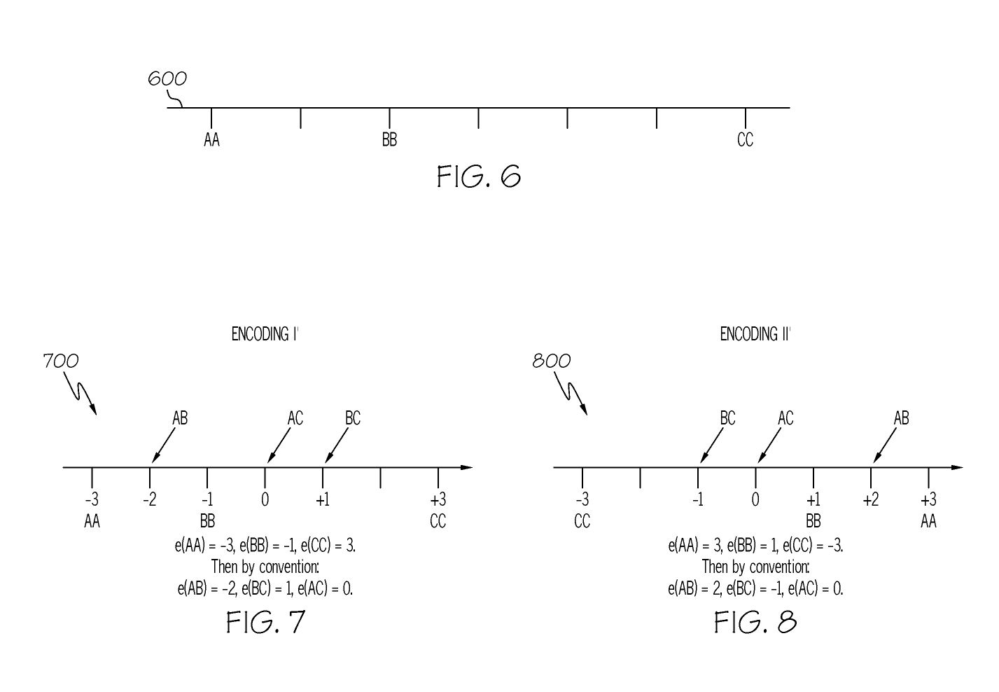

Now consider a multi-allelic loci example. In this example, only a three-allelic case is discussed. However, the following discussion is applicable to any number of multiple allelic values. In this example, the tri-allelic locus takes the possible values A, B, C with estimated quantitative values. The input is the number of distinct allelic forms such as A, B and C and a relative placement of the homozygous genotypes on a contribution line 600 for the locus, as shown in FIG. 6. It should be noted that, in one embodiment, a user (or application) provides this relative placement of the homozygous genotypes.

For example, FIG. 6 shows AA on the left side (negative contribution) of the contribution line 600, CC on the right side (positive contribution) of the contribution line 600, and BB between AA and CC with a negative contribution (to the left of the center of the contribution line 600). In this example, the possible genotypes in a diploid are AA, BB, CC, AB, AC, and BC, The two encodings, Encoding I′ 700 and Encoding II′ 800 for the contribution line 600 of FIG. 6 are shown in FIGS. 7 and 8, respectively. It should be noted that the minimal encoding values (e.g., −3, . . . , +3) are selected by the interaction model generator 109 such that every homozygous pair is on an integer, all heterozygous (midpoints) are on an integer, and no homozygous and heterozygous overlap.

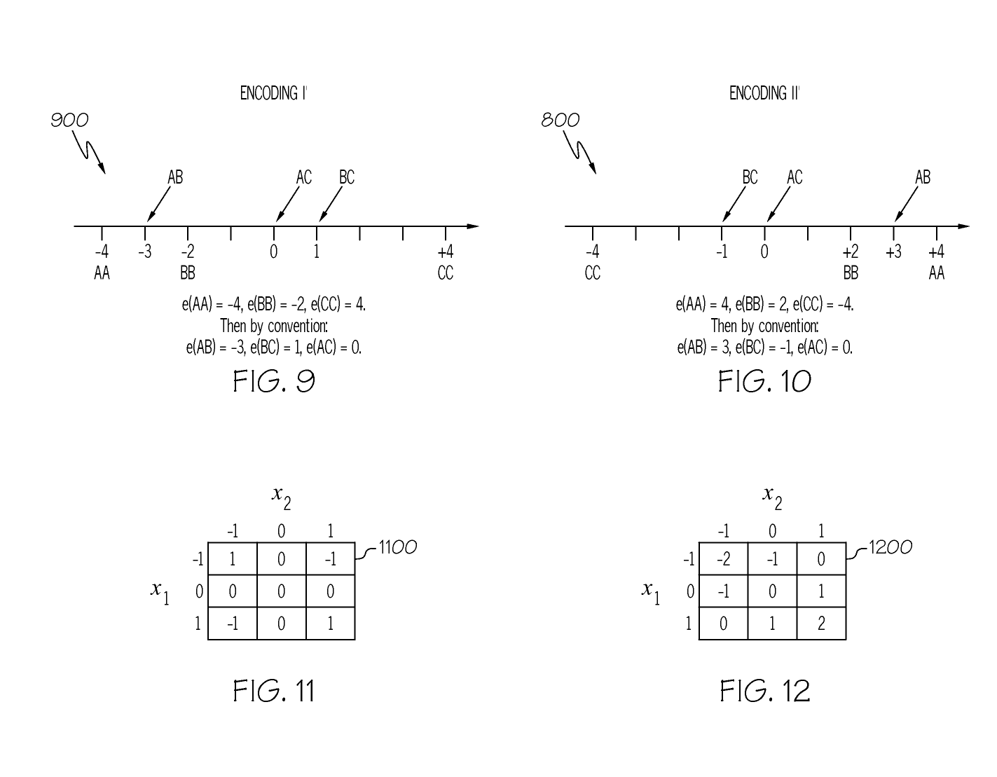

In one embodiment, the placement of the genotypes on a contribution line needs to be adjusted such that a homozygous and a heterozygous genotype value do not overlap when their orientation is flipped on the contribution line. In the contribution lines shown in FIGS. 7 and 8 BB in Encoding I′ 700 is at −1 and BC is at +1 in Encoding II 800. Therefore, the inverse of BB's position overlaps the position of BC and vice versa, and the granularity of the contribution lines needs to be adjusted. FIGS. 9 and 10 show the contribution lines 900, 1000 for Encoding I′ and Encoding II′ after a granularity adjustment process has been performed. In particular, FIGS. 9 and 10 show that the granularity of the contribution lines has been adjusted from 7 to 9. FIG. 9 also shows that AA, AB, and BB have been shifted to the left by one position, and CC has been shifted to the right by 1 position. FIG. 10 shows a similar adjustment for the inverse encoding of Encoding II′.

The granularity of an encoding bestows on the model finer or coarser level of control. In this context, the following definition applies: a grain is the number of distinct levels identified by the model. In one embodiment an encoding that centers at 0 is used when modeling interactions. A zero-centered encoding is possible no matter what the relative placements of the homozygous quantities. For example in the bi-allelic case for Encoding I, the following encoding is used: aa (−1), aA (0), AA (+1) and not aa (−1), aA (0), (+2). This model has a granularity of 3 or grain=3. A similar encoding is used for the multi-allelic case, such as that shown in EQ 1 below:

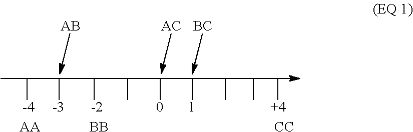

This encoding/model has a granularity of 9 or grain=9.

In one embodiment, there can be different, but equivalent, encodings. A model is zero-centered, if 0 is the average of the maximum and minimum values being considered. Note that, in one embodiment, every zero-centered encoding has a minimum of 3 grains and always an odd number of grains. It should be noted that zero-centered and non-zero-centered models are related. For example, consider the following where βⱼ=r for locus j. Let M_{z} denote a zero-centered model and M [symbol] , otherwise.

TABLE 1

| M_{z} (Zero-centered) | | | [symbol] (not Zero-centered) | | |
|---|---|---|---|---|---|
| value vⱼ^{Z} | Enc. I | Enc. II | Enc. I | Enc. II | value [symbol] |
| −βⱼ | −1 | (or 1) | 0 | (or 2) | 0 |
| 0 | 0 | | 1 | | βⱼ |
| βⱼ | 1 | (or −1) | 2 | (or 0) | 2βⱼ |

As can be seen in TABLE 1 above, one value is an affine transform of the other:

vⱼ^{z}=vⱼ [symbol] −βⱼ (EQ 2).

In one embodiment, the quantitative value of an individual is calculated as the sum of all the values over all the loci, provided there are no interactions between the loci. The quantitative value is a quality, characteristic, etc. that can be measured or quantified on the biological organism being studied. For example, plant height, disease resistance, color, time to produce seeds, etc. In one embodiment, an error component can be added. For example, consider a fixed individual, and let the genotype at locus i of this individual be Gᵢ. Then the value v of this individual (without interactions) is:

$$v = {\sum }_{i} {r}_{i} {x}_{i} = {\sum }_{i} {β}_{i} {x}_{i} , \\ where \\ {x}_{i} = e ( {G}_{i} ) . \qquad ( EQ 3 )$$

FIGS. 11-13 show various bi-allelic loci interaction models 1100, 1200, 1300 utilized by the interaction model generator 109 to generate a quantitative multi-allelic, k-way interaction model. Each of these models 1100, 1200, 1300 is a 2-way interaction model since they are modeling interactions between two genes x₁ and x₂. In particular, FIG. 11 shows a first model, Model E1 1100, which is a minimal (3-grain) 2-way interaction model. The outer positions 1102, 1104 on the x-axis and y-axis of the E1 model 1100 are associated with the possible genotypes of genes x₂ and x₁, respectively. For example, for the bi-allelic locus (a, A) x₁ and x₂ each of these positions corresponds to aa, aA, and AA going from left to right on the x-axis and top to bottom on the y-axis. The values at each of these outer positions represent the contributions of a genotype to the physical trait being simulated. Each position 1106 within the E1 model 1100 indicates the contribution of the interaction between the two corresponding genotypes on the physical trait being simulated. For example, the contribution of the interaction between genotype aa for gene x₁ and genotype aa for gene x₂ is 0 based on the E1 model 1100. In one embodiment, the E1 model 1100 can be represented in the following closed algebraic form for 2-way interactions: x₁x₂. The E1 model 1100 can also be represented in the following closed algebraic form for k-way interactions: Πxᵢ.

FIG. 12 shows a second interaction model, E2 model 1200, which is a more refined (5-grain) 2-way interaction model. Similar to the E1 model 1100, the outer positions 1202, 1204 on the x-axis and y-axis of the E2 model 1200 represent the possible genotypes of each gene x₁ and x₂ and their respective contributions. Each position 1206 within the E2 model 1200 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is −2. The E2 model 1200 can be represented in the following closed algebraic form for 2-way interactions: x₁+x₂. The E2 model 1200 can also be represented in the following closed algebraic form for k-way interactions as follows: Σxᵢ.

FIG. 1300 shows a third model, E3 model 1300, which is a 9-grain 2-way interaction model. Similar to the E1 and E2 models 1100, 1200, the outer positions 1302, 1304 on the x-axis and y-axis of the E3 model 1300 represent the possible genotypes of each gene x₁ and x₂ and their respective contributions. For example, for bi-allelic loci (a, A) each or these positions corresponds to aa, AA, and aA. Each position 1306 within the E3 model 1300 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is −4. The E3 model 1300 can be represented in the following closed algebraic form for 2-way interactions as follows: (1+x₁x₂)(x₁+x₂). The E3 model 1200 can also be represented in the following closed algebraic form for k-way interactions as follows: (1+Πxᵢ)Σxᵢ. It should be noted that some of the interaction models discussed above may increase the grain value (E2, E3 in the bi-allelic and E1, E2, E3 in the multi-allelic case). This is because the interactions may involve contributions at a finer granularity, which is translated in these models as increase in the grain value.

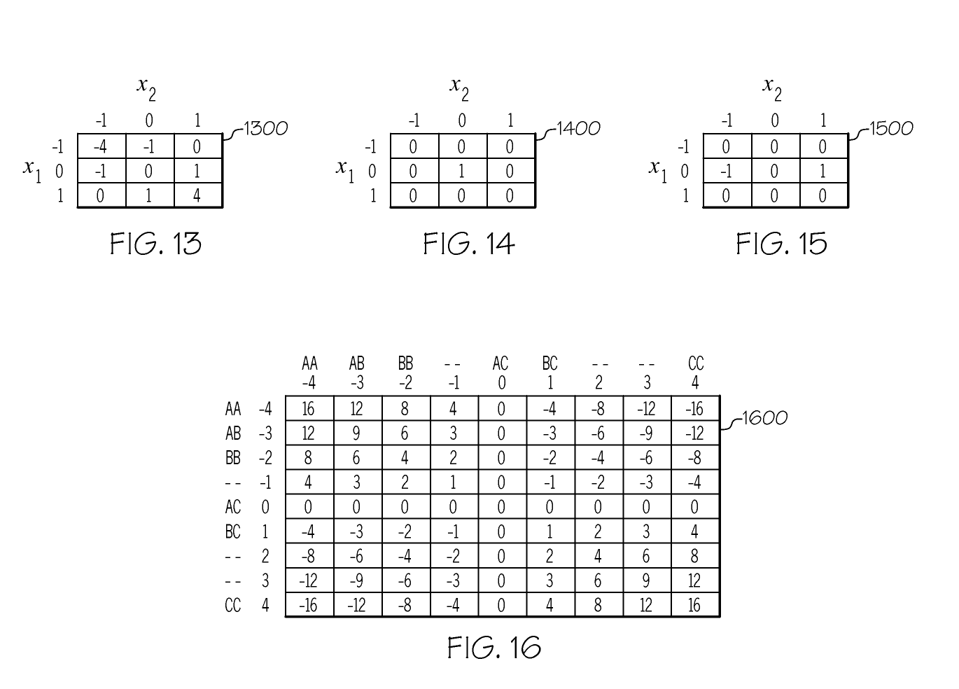

FIGS. 14-15 show dominance models with a minimum level of granularity. Dominance is specific type of interaction where on allele masks the expression (phenotype) of another allele at the same locus. FIG. 14 shows a first dominance model, D1 model 1400, that models interaction with dominance in all loci. Similar to the E1, E2, and E3 models discussed above, the outer positions 1402, 1404 on the x-axis and y-axis of the D1 model 1400 represent the possible genotypes of each gene x₁ and x₂ and their respective contributions. For example, for bi-allelic loci (a, A) each or these positions corresponds to aa, AA, and aA. Each position 1406 within the D1 model 1400 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is 0. The D1 model 1400 can be represented in the following closed algebraic form for 2-way interactions as follows: (1−|x₁|)(1−|x₂|). The D1 model 1400 can also be represented in the following closed algebraic form for k-way interactions as follows: Π(1−|xᵢ|).

FIG. 15 shows a second dominance model, D2 model 1500, that models interaction with dominance in only the first l loci (for 2-way, l=1). Similar to the E1, E2, E3, and D1 the outer positions on the x-axis and y-axis of the D2 model 1500 represent the possible genotypes of each gene x₁ and x₂ and their respective contributions. For example, for bi-allelic loci (a, A) each or these positions corresponds to aa, AA, and aA. Each position 1500 within the D2 model 1500 indicates the contribution of the interaction between the two corresponding genotypes on the physical trait being simulated. For example, considering a bi-allelic locus (a, A) for each of x₁ and x₂ with genotypes aa, aA, and AA the contribution of the interaction between genotype aa for x₁ and genotype aa for x₂ is 0. The D2 model 1500 can be represented in the following closed algebraic form for 2-way interactions: (1−|x₁|) x₂. The D2 model 1500 can also be represented in the following closed algebraic form for k-way interactions as:

$${\prod }_{i = 1}^{l} ( 1 - \vert {x}_{i} \vert ) {\prod }_{i = l + 1}^{k} {x}_{i} .$$

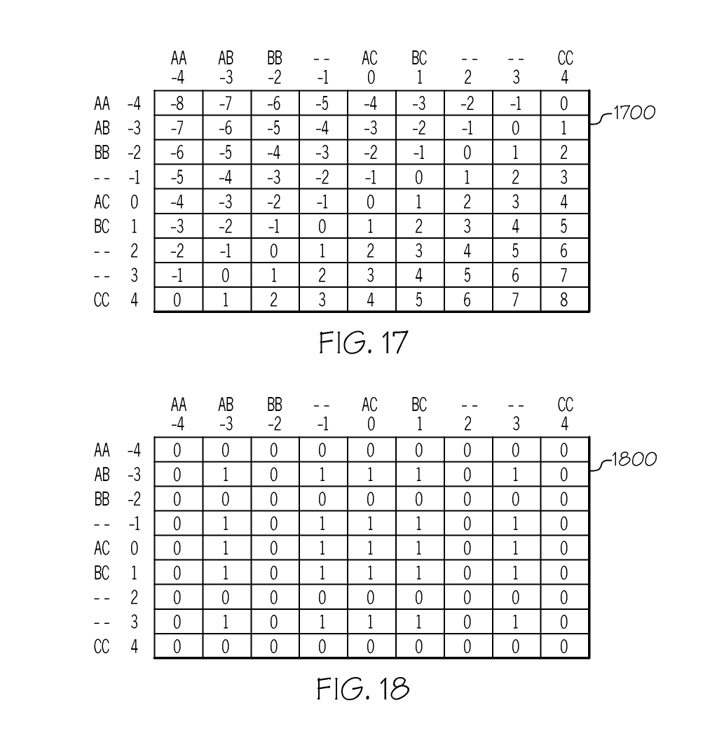

FIG. 16 shows one example of an E1 model 1600 for multi-allelic loci. FIG. 17 shows one example and an E2 model 1700 for multi-allelic loci. A model similar to that of model E3 is also applicable to multi-allelic loci as well. The examples shown in FIGS. 16 and 17 are based on the granularity layout of EQ 1. The structure of these models 1600, 1700 is similar to the models shown in FIGS. 11-13, except the models shown in FIGS. 16-17 are directed to multi-allelic loci. Therefore, the discussion of the structure for the models 1100, 1200, 1300 in FIGS. 11-13 is also applicable to the models 1600, 1700 shown in FIGS. 16-17. The algebraic representations of models E1, E2, E3 shown in FIGS. 11-13 also hold for the models shown in FIGS. 16 and 17 and a similar multi-allelic E3 model (not shown). FIG. 18 shows one example of a D1 model 1800 for multi-allelic loci. The example shown in FIG. 18 is based on the granularity layout of EQ 1. The discussion of the structure for the D1 model 1500 of FIG. 15 is also applicable to the D1 model 1800 shown in FIG. 18, The multi-allelic dominance model shown in FIG. 18 can be represented using the following piecewise polynomial form:

$${D}_{k} ( {x}_{{i}_{1}} , … , {x}_{{i}_{k}} ) = \{ \begin{matrix}1 , & if for each {x}_{i} , \vert {x}_{i} \vert = 0 , 1 , or 3 , \\ 0 , & otherwise .\end{matrix} \qquad ( EQ 4 ) .$$

It should be noted that the D2 model shown in FIG. 15 can also be extended to multi-allelic loci. For example, for multi-allelic D2 with dominance in only first l loci (for 2-way, l=1) the corresponding multi-allelic dominance model can be represented as follows:

$${D}_{k} ( {x}_{{i}_{1}} , … , {x}_{{i}_{k}} ) = f ( {x}_{{i}_{1}} , … , {x}_{{i}_{l}} ) {x}_{{i}_{l + 1}} … {x}_{{i}_{k}} , \\ where f ( {x}_{{i}_{1}} , … , {x}_{{i}_{l}} ) = \{ \begin{matrix}1 , & if for each {x}_{j} , 1 \leq j \leq l , \vert {x}_{i} \vert = 0 , 1 , or 3 , \\ 0 , & otherwise .\end{matrix} \qquad ( EQ 5 ) .$$

In one embodiment, the interaction model generator 109 calculates the quantitative value of an individual with k-way interactions as the addition of the contributing factors of each locus i, along with the interaction factors provided by models one (or more) of the E1, E2, and E3 models shown in FIGS. 11-13 and 16-17 and optionally one (or more) of the D1 and D2 models shown in FIGS. 14-15 and 18. Based on EQ 3 and the closed forms of the interaction models discussed above with respect to FIGS. 11-18, the quantitative value of an individual j is:

$${V}_{j} = {\sum }_{i} {β}_{i} {x}_{ij} + {\sum }_{{i}_{1} > {i}_{2} > … > {i}_{k}} ( {α}_{{i}_{1} … {i}_{k}} {E}_{k} ( {x}_{{i}_{1}} , … , {x}_{{i}_{k}} ) + {γ}_{{i}_{1} … {i}_{k}} {D}_{k} ( {x}_{{i}_{1}} , … , {x}_{{i}_{k}} ) ) , \qquad ( EQ 6 )$$

for some real βᵢ, αᵢ_{₁}_{>i}_{₂}_{> . . . >i}_{ₖ} and γᵢ_{₁}_{>i}_{₂}_{> . . . >i}_{ₖ}. Variable j is the individual, i is a locus, k is an integer (the number of interacting loci), β is an impact scaling factor for locus i, α is a scaling factor for the contribution of the interaction between the k loci based on interaction model E, γ is a scaling factor for the contribution of the interaction between the k loci based on a dominance interaction model D, xij is the encoding of gene (locus) i of the individual j being considered, E is the interaction model selected by the user, and D is the dominance model (if any) selected by the user.

EQ 6 shown above, is a model of the quantitative value of an individual. Each individual j has its own composition of alleles at each locus/gene (encoded by xᵢⱼ). The scale of the effect of locus i is determined by the parameter βᵢ. If βᵢ is large then locus i has a large contribution to the quantitative value. Similarly if βᵢ is small then locus i has a small contribution to the quantitative value. Each locus/gene can individually contribute (positively or negatively) to the quantitative value (the first sum). Moreover, the loci can interact to contribute to the quantitative value. In one embodiment, there are five types of interactions (E1, E2, E3, D1, D2), which can involve k many loci. The parameters α and γ gamma are the scale of the contribution of those particular loci to the quantitative value.

In one embodiment, the error or the environmental factor can be modeled over the individual as eⱼ. Then the modified value of the individual j is

V_{j′}=Vⱼ+eⱼ_{^{•}}. (EQ 7).

Recall that Encodings I and II refer to the orientation of the relative placement of the estimates of the homozygous genotypes. In a prediction problem, this orientation also needs to be computed. Therefore, one or more embodiments provide a transformation between the values obtained from Encodings I and II discussed above. With respect to linear invariance, let v_{I} be the value obtained from Encoding I and v_{II} from Encoding II. Then the model is linear invariant if one value is a linear transform of the other. A linear invariance property can be defined as follows: let Gᵢ be the genotype value of locus i of an individual. Let

xᵢ=e_{I}(Gᵢ) and x̅ᵢ=e_{II}(Gᵢ)

for Encodings I and II. Then, without loss of generality, for all the interaction models (E1, E2, E3, D1, D2): For Models E1, D1:

$${\sum }_{i = 1}^{k} {β}_{i} {x}_{ij} + {α}_{{i}_{1} … {i}_{k}} {E}_{k} ( {x}_{{i}_{1}} , … , {x}_{{i}_{k}} ) + {γ}_{{i}_{1} … {i}_{k}} {D}_{k} ( {x}_{{i}_{1}} , … , {x}_{{i}_{k}} ) = {\sum }_{i = 1}^{k} {β}_{i} {\overline{x}}_{i} + {α}_{{i}_{1} … {i}_{k}} {E}_{k} ( {\overline{x}}_{{i}_{1}} , … , {\overline{x}}_{{i}_{k}} ) + {γ}_{{i}_{1} … {i}_{k}} {D}_{k} ( {\overline{x}}_{{i}_{1}} , … , {\overline{x}}_{{i}_{k}} ) . \qquad ( EQ 8 )$$

For models E2, E3, and D2:

$${\sum }_{i = 1}^{k} {β}_{i} {x}_{i} + {α}_{{i}_{1} … {i}_{k}} {E}_{k} ( {x}_{{i}_{1}} , … , {x}_{{i}_{k}} ) + {γ}_{{i}_{1} … {i}_{k}} {D}_{k} ( {x}_{{i}_{1}} , … , {x}_{{i}_{k}} ) = {\sum }_{i = 1}^{k} - {β}_{i} {\overline{x}}_{i} + {α}_{{i}_{1} … {i}_{k}} {E}_{k} ( {\overline{x}}_{{i}_{1}} , … , {\overline{x}}_{{i}_{k}} ) - {γ}_{{i}_{1} … {i}_{k}} {D}_{k} ( {\overline{x}}_{{i}_{1}} , … , {\overline{x}}_{{i}_{k}} ) . \qquad ( EQ 9 )$$

Note that in each of the zero-centered models,

x̅ᵢ=e_{II}(Gᵢ)=−e_{I}(Gᵢ)=−xᵢ. (EQ 10)

Next, consider model E1. Let k be even, then

Πxᵢ=Π(−xᵢ)

[symbol]

Eₖ(xᵢ_{₁}, . . . ,xᵢ_{ₖ})=Eₖ( x̅ᵢ_{₁}, . . . , x̅ᵢ_{ₖ})

Let k be odd, then

Πxᵢ=−Π(−xᵢ)

[symbol]

Eₖ(xᵢ_{₁}, . . . ,xᵢ_{ₖ})=−Eₖ( x̅ᵢ_{₁}, . . . , x̅ᵢ_{ₖ})

Consider model E2:

Σxᵢ=−Σ(−xᵢ),

[symbol]

Eₖ(xᵢ_{₁}, . . . ,xᵢ_{ₖ})=−Eₖ( x̅ᵢ_{₁}, . . . , x̅ᵢ_{ₖ}).

Consider model E3. From the above,

Eₖ(xᵢ_{₁}, . . . ,xᵢ_{ₖ})=−Eₖ( x̅ᵢ_{₁}, . . . x̅ᵢ_{ₖ}),

when k is odd,

Eₖ(xᵢ_{₁}, . . . ,xᵢ_{ₖ})=Eₖ( x̅ᵢ_{₁}, . . . , x̅ᵢ_{ₖ}),

when k is even.

Next, consider the D1 model.

Π(1−|xᵢ|)=Π(1−| x̅ᵢ|)

[symbol]

Eₖ(xᵢ_{₁}, . . . ,xᵢ_{ₖ})=Eₖ( x̅ᵢ_{₁}, . . . x̅ᵢ_{ₖ}).

Consider the D2 model. When k−l is even,

Dₖ(xᵢ_{ₗ}, . . . ,xᵢ_{ₖ})=Dₖ( x̅ᵢ_{ₗ}, . . . , x̅ᵢ_{ₖ}),

and when k−l is odd

Dₖ(xᵢ_{₁}, . . . ,xᵢ_{ₖ})=−Dₖ( x̅ᵢ_{₁}, . . . , x̅ᵢ_{ₖ}).

Consider EQs 4, 5 for the multi-allelic dominance models. Again, the same results as above hold. Since for each of the models

Eₖ(xᵢ\textcircled{1}, . . . ,xᵢ_{ₖ})=±Eₖ( x̅ᵢ_{₁}, . . . , x̅ᵢ_{ₖ})

or

Dₖ(xᵢ_{₁}, . . . ,xᵢ_{ₖ})=±Dₖ( x̅ᵢ_{₁}, . . . , x̅ᵢ_{ₖ})

the respective values are linearly invariant, hence the result.

With respect to simulations and predictions, let F denote the set of factors βᵢ, αᵢ_{₁}_{>i}_{₂}_{> . . . >i}_{ₖ} and γᵢ_{₁}_{>i}_{₂}_{> . . . >i}_{ₖ} over all the loci of EQ 6. For simulations, both Encoding (I or II) and F are fixed, and the form does not matter. However, in one embodiment, the form is a general form that can be programmed. The value Vⱼ is computed for simulations. For predictions, neither Encoding (I or II) nor F are known. In one embodiment, the form is an algebraic form. The value Vⱼ is used in F estimations.

The discussion above shows that that Encoding I/II is an important unknown in the prediction problem and an important consideration in the simulation problem. In one embodiment, there is a linear transformation between these two Encodings. The above discussion also shows that the interaction models of FIGS. 11-18 are zero-centered models and not only is the transformation linear but the linear factor is ±1. Based on the above, the interaction model generator 109 generates/builds a multi-allelic, k-way interaction model. The effective interaction model generated by interaction model generator 109 is the sum of the E and (optionally) the D (dominance) model, as shown in EQ 6.

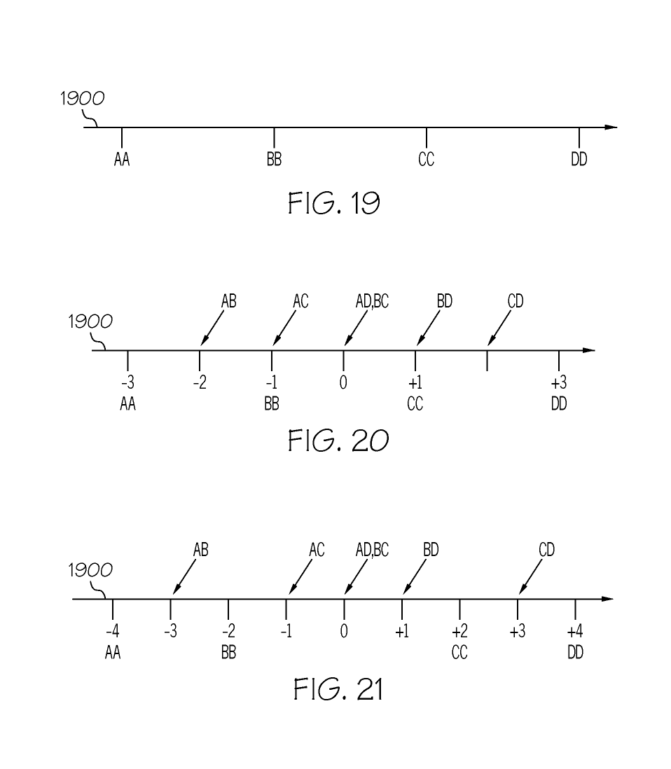

For example, the interaction model generator 109 takes as input the number of distinct allelic forms for each of a plurality of genes/loci. In this example, the distinct allelic forms is (A, B, C, D). The interaction model generator 109 also takes as input a given relative placement of the possible homozygous pairs of the alleles on a contribution line 1900 for each of the plurality of genes/loci, as shown in the example of FIG. 19. Based on this input, the interaction model generator 109 computes heterozygous values as the average of the corresponding homozygous values. For example, FIG. 20 shows that that interaction model generator 109 has generated the heterozygous genotypes AB, AC, AD, BC, BD, CD based on the homozygous values AA BB, CC, DD. The interaction model generator 109 has also determined the contribution values of each heterozygous genotype as the average of a given heterozygous genotype's corresponding homozygous genotypes. For example, AB is associated with a contribution value of −2 since AA is associated with −1 and BB is associated with −3.

The interaction model generator 109 determines if any of the homozygous positions and heterozygous positions overlap on the contribution line for each of the plurality of genes. If so, the interaction model generator 109 adjusts the grain of the contribution line such that no homozygous positions and heterozygous positions overlap. For example, the interaction model generator 109 starts with minimal granularity and attempts to place homozygous pairs on integers such that homozygous and heterozygous do not overlap. If not non-overlapping positions are not found with the minimal granularity, the interaction model generator 109 increases the granularity by a given number and repeats this process until no homozygous and heterozygous values overlap. In the current example, this process results in genotype placement on the contribution line 1900 shown in FIG. 21. FIG. 21 shows that this gran adjustment process increased the grain of the contribution line 1900 in FIG. 20 from 7 to 9.

The interaction model generator 109 also receives a selection of a predefined interaction model and a predefined dominance model (if dominance is being accounted for). For example, assume that the user has selected the E2 model 100 and the D1 model 1400. The interaction model generator 109 outputs a model of genetic value Vⱼ for an individual in the form of

$$\begin{matrix}\begin{matrix}{V}_{j} = {\sum }_{i} {β}_{i} {x}_{ij} + {\sum }_{{i}_{1} > … > {i}_{k}} ( \begin{matrix}{α}_{{i}_{1} , … , {i}_{k}} {E}_{2} ( {x}_{{i}_{1}} , … , {x}_{{i}_{k}} ) + \\ {γ}_{{i}_{1} , … , {i}_{k}} {D}_{1} ( {x}_{{i}_{1}} , … , {x}_{{i}_{k}} )\end{matrix} ) \\ = {\sum }_{i} {β}_{i} {x}_{ij} + {\sum }_{{i}_{1} > … > {i}_{k}} ( {α}_{{i}_{1} , … , {i}_{k}} {\sum }_{l = 1}^{k} {x}_{l} + {γ}_{{i}_{1} , … , {i}_{k}} {D}_{1} ( {x}_{{i}_{1}} , … , {x}_{{i}_{k}} ) )\end{matrix} \\ where \\ {D}_{1} ( {x}_{1} , … , {x}_{k} ) = \{ \begin{matrix}1 & if for each {x}_{i} , \vert {x}_{i} \vert = 0 , 1 , or , 3 \\ 0 & otherwise\end{matrix}\end{matrix}$$

and xᵢ is the encoding of genotype defined in step 2.

That is, the output the interaction model generator 109 in this example is a model of genetic value where each loci has four alleles, each locus has 9 grains, the epistasis interaction is model E2 (sum of loci effects), and the dominance model is D1 (zero contribution if homozygous pair present).

The generated quantitative model can be used in a prediction problem or for a simulation. In a prediction problem, the goal is the train (learn) on existing data and use the model to make prediction on the future. For example, one can grow 100 plants, record their plant height (example of quantitative value), then sequence their genomes. Then one can train (estimate the parameters beta, alpha, gamma) the quantitative model (EQ. 6) using this data. In the future, new plants can be taken and the genome sequenced. A prediction can then be performed using the quantitative model for a given characteristic such as a height, which saves time and money as compared to growing the actual plants. With respect to a simulation, one can randomly generate all beta, alpha, and gamma parameters from a normal distribution, and simulate the genomes of a population. Using the randomly generated parameters, the simulated genomes, and the quantitative model generated by the interaction model generator 109, the quantitative value of all individuals can be simulated.

Operational Flow Diagrams

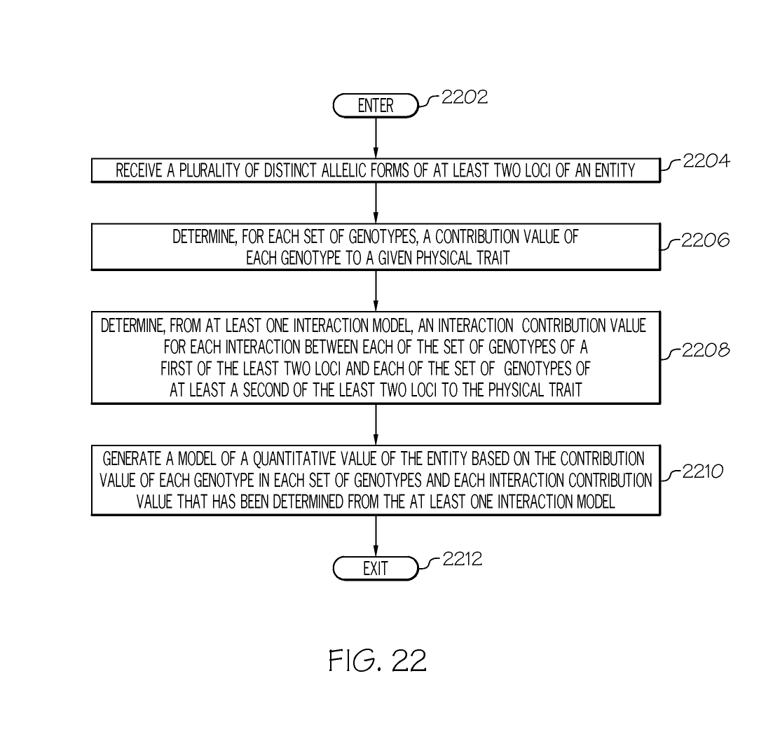

FIG. 22 is an operational flow diagram illustrating one example of an overall process for generating a quantitative model of multi-allelic multi-loci interactions. The operational flow diagram begins at step 2200 and flows directly to step 2204. The interaction model generator 109, at step 2204, receives a plurality of distinct allelic forms of at least two genes of an entity is. Each of the plurality of distinct allelic forms is associated with a set of genotypes. The interaction model generator 109, at step 2206, determines a contribution value of each genotype to a given physical trait for each set of genotypes. The interaction model generator 109, at step 2208 determines, from at least one interaction model, an interaction contribution value for each interaction between each of the set of genotypes of a first of the least two genes and each of the set of genotypes of at least a second of the least two genes to the physical trait. The interaction model generator 109, at step 2210, generates a model of a quantitative value of the entity based on the contribution value of each genotype in each set of genotypes and each interaction contribution value that has been determined from the interaction model. The control flow exits at step 2212.

Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for generating a quantitative model of multi-allelic multi-loci interactions, the computer implemented method comprising:
receiving, by a processor, a plurality of distinct allelic forms of at least two loci of an entity, wherein each plurality of distinct allelic forms is associated with a set of genotypes;
determining, for each set of genotypes, a contribution value of each genotype to a given physical trait;
determining, from at least one interaction model, an interaction contribution value for each interaction between each of the set of genotypes of a first of the least two loci and each of the set of genotypes of at least a second of the least two loci to the physical trait; and
generating a model of a quantitative value of the entity based on the contribution value of each genotype in each set of genotypes and each interaction contribution value that has been determined from the at least one interaction model.

2. The computer implemented method of claim 1, wherein the model of the quantitative value is defined as:
$${V}_{j} = {\sum }_{i} {β}_{i} {x}_{ij} + {\sum }_{{i}_{1} > {i}_{2} > … > {i}_{k}} ( {α}_{{i}_{1} … {i}_{k}} {E}_{k} ( {x}_{{i}_{1}} , … , {x}_{{i}_{k}} ) ) ,$$
where V is the quantitative value, j is an individual under consideration, i is a locus, k is an integer identifying a number of interacting loci, β is an impact scaling factor for locus i, α is a scaling factor for a contribution of an interaction between the k loci based on an interaction model E, and xᵢⱼ is an contribution encoding of locus i with respect to the given physical trait.

3. The computer implemented method of claim 1, further comprising:
determining, from at least one dominance based interaction model, an interaction contribution value for each interaction between each of the set of genotypes of a first of the least two loci and each of the set of genotypes of at least a second of the least two loci to the physical trait,
wherein the model of the quantitative value of the entity is further generated based on the each interaction contribution value that has been determined from the at least one dominance based interaction model.

4. The computer implemented method of claim 1, wherein the model of the quantitative value is defined as:
$${V}_{j} = {\sum }_{i} {β}_{i} {x}_{ij} + {\sum }_{{i}_{1} > {i}_{2} > … > {i}_{k}} ( {α}_{{i}_{1} … {i}_{k}} {E}_{k} ( {x}_{{i}_{1}} , … , {x}_{{i}_{k}} ) + {γ}_{{i}_{1} … {i}_{k}} {D}_{k} ( {x}_{{i}_{1}} , … , {x}_{{i}_{k}} ) ) ,$$
where V is the quantitative value, j is an individual under consideration, i is a locus, k is an integer identifying a number of interacting loci, β is an impact scaling factor for locus i, α is a scaling factor for a contribution of an interaction between the k loci based on an interaction model E, γ is a scaling factor for the contribution of the interaction between the k loci based on a dominance interaction model D, and xᵢⱼ is an contribution encoding of locus i with respect to the given physical trait.

5. The computer implemented method of claim 1, wherein the at least one interaction model comprises one of:
an interaction model defined as øxᵢ;
an interaction model defined as Σxᵢ; and
an interaction model defined as (1+Πxᵢ)Σxᵢ,
where x is a contribution encoding of locus i to the given physical trait.

6. The computer implemented method of claim 5, wherein the at least one interaction model further comprises one of:
a dominance based interaction model defined as:
$${D}_{k} ( {x}_{{i}_{1}} , … , {x}_{{i}_{k}} ) = \{ \begin{matrix}1 , & if for each {x}_{i} , \vert {x}_{i} \vert = 0 , 1 , or 3 , \\ 0 , & otherwise .\end{matrix}$$
and
a dominance based interaction model defined as:
$${D}_{k} ( {x}_{{i}_{1}} , … , {x}_{{i}_{k}} ) = f ( {x}_{{i}_{1}} , … , {x}_{{i}_{l}} ) {x}_{{i}_{l + 1}} … {x}_{{i}_{k}} , \\ where f ( {x}_{{i}_{1}} , … , {x}_{{i}_{l}} ) = \{ \begin{matrix}1 , & if for each {x}_{j} , 1 \leq j \leq l , \vert {x}_{j} \vert = 0 , 1 , or 3 , \\ 0 , & otherwise .\end{matrix}$$
where x is a contribution encoding of a locus to the given physical trait, k is an integer identifying a number of interacting loci, l a number of loci from the k loci with dominance, and D is the dominance based interaction model.

7. The computer implemented method of claim 1, wherein each set of genotypes comprises a plurality of homozygous genotypes and a plurality of heterozygous genotypes, and
wherein determining the contribution value of each genotype to a given physical trait comprises:
mapping, for each set of genotypes, each homozygous genotype and each heterozygous genotype in the set of genotypes to a position on a contribution line based on a relative contribution placement associated with each homozygous genotype and each heterozygous genotype, wherein the contribution line represents a relative contribution to the given physical trait by each homozygous genotype and each heterozygous genotype, and wherein the contribution line is associated with a given granularity;
determining if an inverse of the position associated with at least one of the homozygous genotypes overlaps the position of at least one corresponding homogenous genotype; and
adjusting the granularity of the contribution line based on determining that inverse of the position associated with at least one of the homozygous genotypes overlaps the position of at least one corresponding homogenous genotype, wherein the adjusting shifts the position of at least the one corresponding homogenous genotype to a non-overlapping position.

8-20. (canceled)
